(19) United States
(12) Patent Application Publication
(10) Pub. No.: US 2015/0306837 A1
(43) Pub. Date: Oct. 29, 2015

(54) LIQUID METERING METHOD IN THE MANUFACTURE OF PAPERBOARD

(71) Applicant: Greif Packaging LLC, Delaware, OH (US)

(72) Inventors: Christopher A. Krumm, Akron, OH (US); Dale Kiaski, Massillon, OH (US); Paul Light, Wadsworth, OH (US)

(73) Assignee: Greif Packaging LLC, Delaware, OH (US)

(21) Appl. No.: 14/264,657

(22) Filed: Apr. 29, 2014

(51) Int. Cl. B31F 1/28

(52) U.S. Cl. CPC B31F 1/2818; B31F 1/2804; B31F 1/2845

(57) ABSTRACT

A liquid metering system in the manufacture of paperboard includes a moisture applicator roll. The moisture applicator roll is configured to rotate about its axis generally perpendicular to a paperboard material flow stream. As the moisture applicator roll rotates, it has a tangential velocity. The tangential velocity is a percentage of the linear velocity of the paperboard material moving down the flow stream. The moisture applicator roll contacts the material at a contact location. At the contact location, the direction of the tangential velocity of the applicator roll opposes the direction of flow of the material. The percentage of the tangential velocity of the applicator roll relative to the linear velocity of the material is generally in a range from about 2% to about 160%.

### BACKGROUND OF THE INVENTION

1. Technical Field

The present invention relates generally to the field of paperboard manufacturing. More particularly, the invention relates to improved methods for manufacturing paperboard. Specifically, the invention relates to controlling the tangential velocity of a moisture applicator roll to impart a desired moisture percentage by weight into a sheet of material.

2. Background Information

Corrugated paperboard is produced when a sheet of medium material, usually a strong paper made largely of bleached or unbleached sulfate pulp, is corrugated by passing through a corrugating machine. Upon leaving the corrugating machine, the corrugated medium material has a series of flutes formed in a sinusoidal shape when viewed from the side. Adhesive is applied to the crests or apexes of the flutes by a glue applicator roll. Then, a first liner is attached to the corrugated medium atop the adhesive. Thereafter, a second adhesive applicator applies additional adhesive to the flutes spaced opposite the first set of flutes. Then, a second liner is connected to the second set of flutes to create a double-faced sheet of paperboard.

In most corrugating operations, the corrugating rolls used to corrugate and shape the medium material are at a temperature of approximately 300° F. This heat transfers to the medium material as it extends through the corrugating machine which helps cure the adhesive. The adhesive most often used in paperboard manufacture is often a starch-based adhesive that requires heat and pressure as part of the chemical reaction to gelatinize the starch into a film. Then water must be removed from the adhesive, often by the application of more heat, in order to fully cure the adhesive.

One problem that occurs is that most methods of available to heat paper to its desired temperature for bonding on the corrugator simultaneously remove water as the paper is being heated. One way to combat the resulting water removal is to use an infusion or pre-wetting system such as one that tries to inject steam under the web through the surface of the heating device to reduce this moisture loss. This device is very speed dependent and difficult to control. Additionally, since the typical corrugator continually changes speeds in a matter of seconds, and the current methods of heating paper sometimes respond in minutes, it becomes difficult to achieve specific temperature and moisture content independently of one another.

The flatness or dimensional stability of a finished paperboard product is often dependent on the moisture balance between the two outside liners that are bonded to the inner corrugated medium paper web. After the three pieces are combined into a sheet of paperboard, the individual sheets of paper often lose or gain moisture to or from one another and the surrounding atmosphere until an equilibrium condition is reached. In order to achieve optimum flatness, the individual sheets of paper should gain or lose as little moisture as possible during the process and should be as close to their equilibrium moisture as possible upon exiting the corrugating machine. This way, post-warp may be minimized.

Many manufacturers of paperboard have improvised types of improvements and have gained patents on new and unique ways to prevent paperboard warping during manufacture. Namely, U.S. Pat. No. 8,398,802 issued to Kohler discloses a method of adjusting the moisture content in a traveling web of medium material so that the web of medium material comprises a 6-9% weight percentage by moisture prior to corrugating. Then that web of medium material is heated to nearly 100° C. Then the material is corrugated such that the web of medium material retains the 6-9% weight percentage moisture through the corrugating steps. Kohler discloses that this method reduces warping and prevents an evenly applied cured adhesive.

From an academic standpoint, the '802 patent warrants accolades for its apparent control of moisture during the corrugating process. However, it is has been realized that real world applications do not often yield expected results and raise additional issues propagating manufacturing concerns that must be addressed. The present invention addresses these and other issues to cure the concerns.

### SUMMARY

In one aspect, an embodiment of the invention may provide a method comprising the steps of: moving a sheet of material along a first sheet material pathway at a first linear velocity through a paperboard corrugating system, the first linear velocity in a first linear velocity range from 1 Feet Per Minute (FPM) to about 1500 FPM; rotating a moisture applicator roll at a first tangential velocity in a direction opposite that of the moving sheet of material, wherein the first tangential velocity is a first percentage of the linear velocity; wherein the first percentage is in a first tangential velocity percentage range from 20% to 90%; and contacting the moving sheet of material with the moisture applicator roll to apply an aqueous solution at a contact location

In one aspect, an embodiment of the invention may provide a liquid metering system comprising: a moisture applicator roll axially rotatable and connected to a frame, and the roll having an outer surface configured to travel at a tangential velocity; a contact location positioned where a portion of the outer surface of the moisture applicator roll contacts a portion of a material flowing at a linear velocity; wherein the tangential velocity of the roll opposes the direction of flow at the contact location; and wherein the tangential velocity of the applicator roll is a percentage of the linear velocity of the flowing material.

In another aspect, the invention may provide a method for metering an amount of liquid onto a sheet of material, the method comprising the steps of: providing a first applicator roll to meter an amount of liquid onto a sheet of medium material, wherein the first applicator rotates and has a tangential velocity that is a percentage of the linear velocity of the flowing medium material; providing a second applicator roll to meter an amount of liquid onto a first liner material, wherein the second applicator rotates and has a tangential velocity that is a percentage of the linear velocity of the flowing first liner; providing a third applicator roll to meter an amount of liquid onto a second liner, wherein the third applicator rotates and has a tangential velocity that is a percentage of the linear velocity of the second liner.

Another embodiment of an aspect of the invention may provide a liquid metering system in the manufacture of paperboard includes a moisture applicator roll. The moisture applicator roll is configured to rotate about its axis generally perpendicular to a paperboard material flow stream. As the moisture applicator roll rotates, it has a tangential velocity. The tangential velocity is a percentage of the linear velocity of the paperboard material moving down the flow stream. The moisture applicator roll contacts the material at a contact location. At the contact location, the direction of the tangential velocity of the applicator roll opposes the direction of flow of the material. The percentage of the tangential velocity of the applicator roll relative to the linear velocity of the material is generally in a range from about 2% to about 160%.

### BRIEF DESCRIPTION OF THE SEVERAL VIEWS OF THE DRAWINGS

A sample embodiment of the invention, illustrative of the best mode in which Applicant contemplates applying the principles, is set forth in the following description, is shown in the drawings and is particularly and distinctly pointed out and set forth in the appended claims.

The accompanying drawings, which are incorporated in and constitute a part of the specification, illustrate various example methods, and other example embodiments of various aspects of the invention. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 is a side view of a PRIOR ART sheet of manufactured paperboard having the undesirable result of warping;

FIG. 2 is a top view of a PRIOR ART sheet of manufactured paperboard having the undesirable result of delamination;

FIG. 3 is a schematic side view of the system of the present invention for producing a sheet of manufactured paperboard;

FIG. 4 is a side view of a conditioning apparatus of the present invention;

FIG. 4A is a side view of a metering rod assembly having a rod and threads;

FIG. 4B is a cross section view of the metering rod and threads positioned closely adjacent an applicator roll to meter an amount of liquid onto the outer surface of the applicator roll;

FIG. 5 is a side view of a heating apparatus of the present invention;

FIG. 6 is a side view of a single facing machine of the present invention, the single facing machine including a corrugating device to corrugate a medium material and a pressuring exerting device to attach a first liner to the corrugated medium;

FIG. 7 is a side view of an adhesive applicator apparatus of the present invention;

FIG. 8 is a side view of a double backer machine, the double backer including a set of rollers to attach a second liner to the corrugated medium material, the double backer also including a set of hot plates to cool the material and cure the adhesive;

FIG. 9 is a side view of a sheet of paperboard manufactured by the method and system of the present invention;

FIG. 10 is a top view of the sheet of paperboard manufactured by the method and system of the present invention;

FIG. 11 is a step-wise graph depicting a series of speed threshold ranges, plotting the tangential velocity of an applicator roll on the y-axis versus the linear velocity of a sheet of traveling web material; and

FIG. 12 is a set of three tables indicated a series of tangential velocity percentage values within given speed threshold for a specific moisture application recipe.

Similar numbers refer to similar parts throughout the drawings.

### DETAILED DESCRIPTION

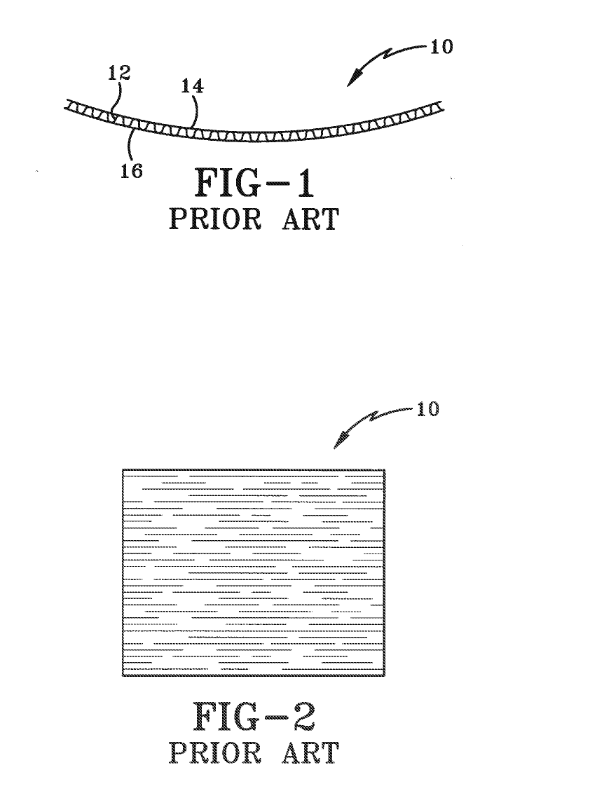

As known in the Prior Art and shown in FIG. 1 (PRIOR ART), a prior art sheet 10 of manufactured paperboard includes a corrugated medium material 12 juxtaposed between a first or top liner 14 and a second or bottom liner 16. During manufacture of prior art paperboard 10, the two outside liners 14, 16 are bonded to arcuate flutes defining the sinusoidally shaped corrugated paper web material 12. After combination into laminate sheets of paperboard 10, the individual sheets, 12, 14, and 16, lose or gain moisture to or from each other and the surrounding atmosphere until an equilibrium condition is reached. Warping occurs when the respective sheets 12, 14, 16 lose moisture at different evaporation rates. This causes paperboard 10 to warp or bow in a manner that reduces the flatness of paperboard 10. As shown in the prior art FIG. 1, when evaporation rates between the three liners are not equal, paperboard 10 can bow upwards forming a concave surface when viewed from the side. Warping is an undesirable result of the paperboard 10 manufacturing process.

As known in the Prior Art and shown in FIG. 2 (PRIOR ART), the prior art paperboard 10 may also have delamination problems caused by unbonded adhesive. Delamination occurs when adhesive is either non-evenly applied to the flutes of the corrugated sheet 14, or when the adhesive does not cure properly. The delamination leaves streaks across paperboard 10. The streaks represent sections of paperboard 10 that either liner 14 or liner 16 is unbonded to corrugated medium 12. The non-bonded portions greatly reduce the strength and structural rigidity of paperboard 10. Delamination is an undesirable result of the paperboard 10 manufacturing process.

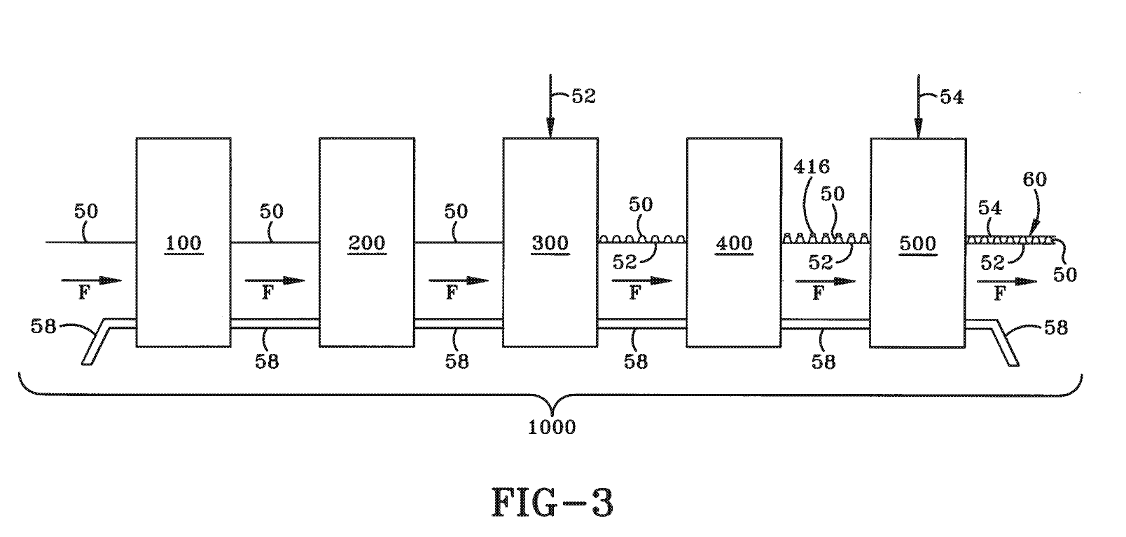

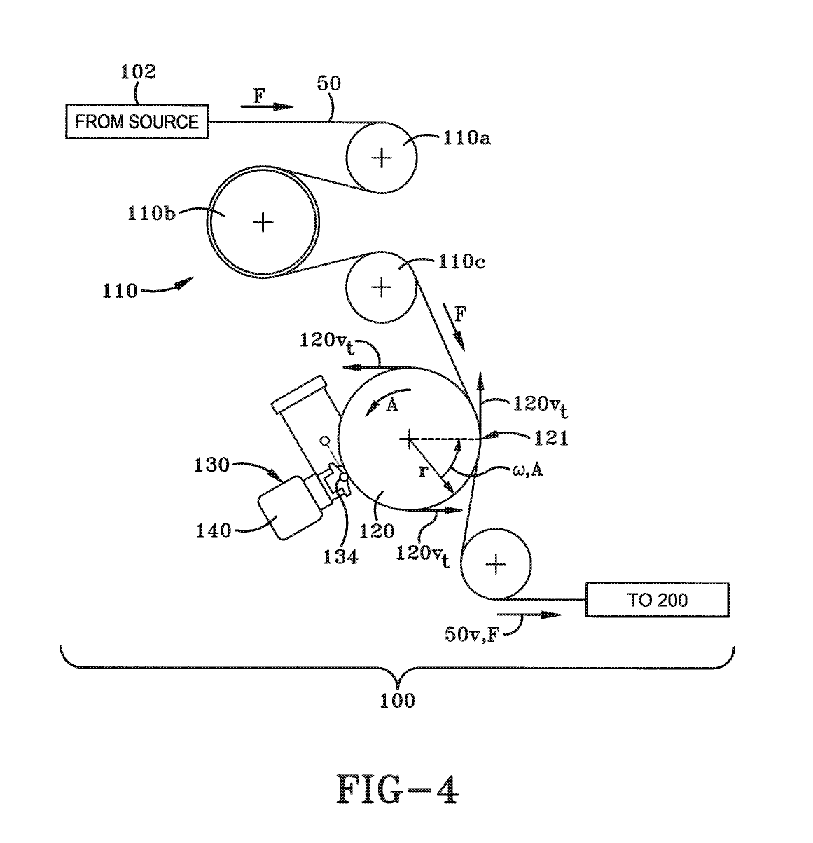

The problems often arising in the prior art, as shown in FIGS. 1 and 2, are reduced by the present invention detailed in FIGS. 3-10. In accordance with an aspect of the present invention shown in FIGS. 3-10, the present invention shown generally as 1000 (FIG. 3) provides a system and a method for moisture and temperature control in the corrugation of paperboard that reduces warping and delamination problems ordinarily associated with the prior art. In accordance with another aspect of the present invention 1000, system provides a method of manufacturing paperboard having the desirable result of being planar or flat with an evenly cured and strong adhesive.

As shown in FIG. 3, a block diagram of an exemplary corrugating apparatus and system 1000 of the present invention is shown schematically. System 1000 includes a medium material conditioning apparatus 100, a web heating arrangement 200, a single facer 300, a glue machine 400, and a double backer 500. The components are arranged in the recited order relative to one corrugating machine direction of a web of medium material 50 as it travels or Flows (Flow represented by Arrow “F”) along a sheet material pathway, wherein the sheet material pathway is defined by the components 100, 200, 300, 400, and 500 of system 1000 in order to produce a finished corrugated product 60 upon exiting double backer 500 as schematically illustrated in FIG. 3. The medium material 50 will become the corrugated web to which a first liner 52 and a second liner 54 will be adhered on opposite sides to produce the finished corrugated paperboard 60. Material 50 can travel generally at a linear velocity 50v in a range from 1 foot per minute (FPM) to about 1500 FPM.

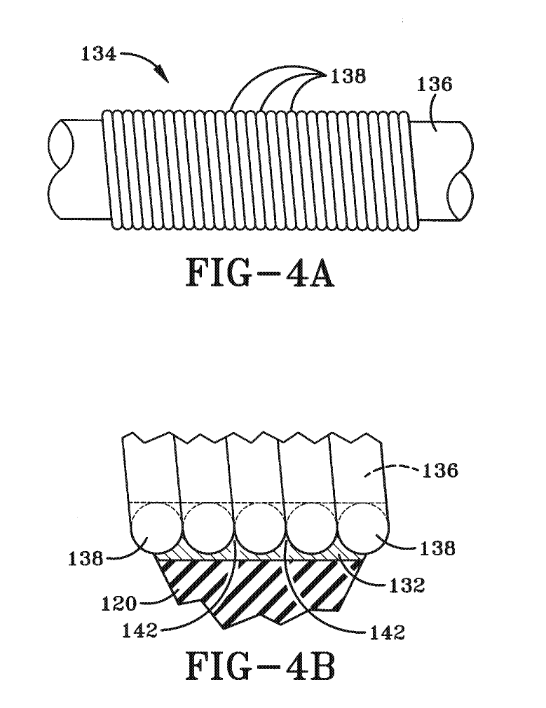

As shown in FIG. 4, conditioning apparatus 100 comprises a pre-tension apparatus 110 including a first roll 110a, second roll 110b and third roll 110c. The three rolls 110a, 110b, 110c are each cylindrical having two ends with a substantially uniform cylindrical sidewall extending therebetween. Rolls 110a, 110b, 110c are connected to a frame 58 and extend laterally approximately perpendicular to flow F direction flowing along the sheet material pathway. Rolls 110a, 110b, 110c are longitudinally adjustable (in the upstream or downstream direction, when viewed from the side; FIG. 4) to control a desired about of tension in material 50 as it flows along the sheet material pathway.

First roll 110a rotates about an axis substantially perpendicular to the downstream direction of flowing material 50 as indicated by Arrow(s) F. Preferably, first roll 110a is positioned vertically above third roll 110c. When viewed from the side (FIG. 4), second roll 110b is positioned longitudinally upstream from rolls 110a and 110c, and second roll 110b is positioned vertically between first roll 110a and third roll 110c. The material pathway extends over the outer surface of each roll 110a, 110b, 110c, thus as material 50 is fed along the pathway, material 50 forms a U-shape (when viewed from the side). Each roll 110a, 110b, and 110c of pre-tension apparatus 110 respectively keep material 50 flowing along the sheet material pathway at a desired tension and speed.

Conditioning apparatus 100 further includes a moisture application roller 120. Roller 120 defines a portion of the sheet material pathway. Moisture applicator roll 120 is configured to increase the amount of moisture percentage by weight (% wt.) within the sheet of material flowing through conditioning apparatus 100. Moisture application roller 120 includes two ends connected to the frame 58 having a cylindrical sidewall extending therebetween. Ends may be connected to the frame 58 via bearing or other conventionally known devices to permit rotation. The cylindrical sidewall of moisture application roller is constructed of a material to attract liquid, preferably an aqueous solution (in this example water). The outer surface of cylindrical sidewall of roller 120 holds water via surface tension forces as roller 120 rotates about an axis. The rotational movement of roller 120 creates a tangential velocity 120vₜ and an angular velocity. Clearly, the tangential velocity 120vₜ and the angular velocity are dependent on radius of cylindrical roller 120. The formulaic relationship is v=rω; where v=the tangential velocity 120vₜ of outer surface of roller 120, r=the radius of roller 120 measured from the center to the outer surface, and ω=the angular velocity of roller 120.

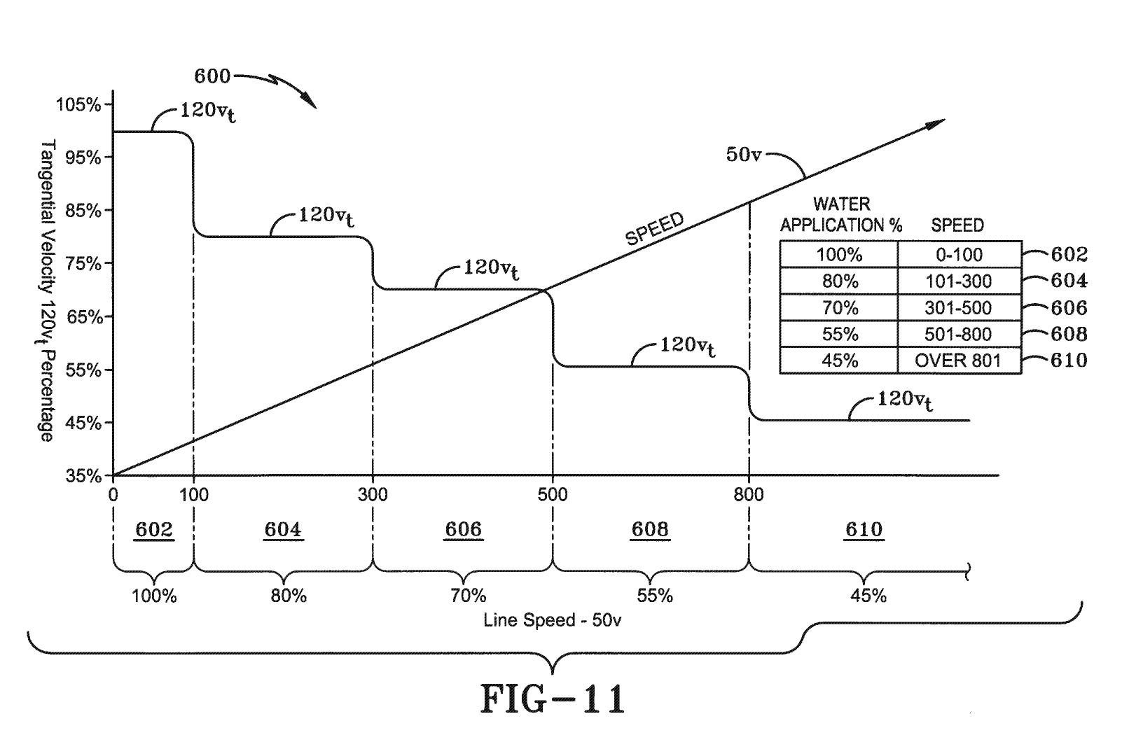

Roller 120 rotates in the direction of Arrow A (FIG. 4). The rotation causes outer surface of roller 120 to move in a direction opposite the direction of material 50 flowing (in the direction of Arrow(s) F) along the sheet material pathway at a surface tangential velocity 120vₜ. The tangential velocity 120vₜ of outer surface of moisture application of roller 120 depends on and is a percentage of the linear speed 50v of material 50 moving F along the sheet material pathway. Further, the tangential velocity 120vₜ of the applicator roll 120 is a percentage of the linear velocity 50v of the flowing sheet of medium material 50 flowing at a speed within a certain speed threshold range (FIG. 11). The moisture roll 120 is rotated at a first tangential velocity 120vₜ in a direction opposite that of the moving sheet of material 50, wherein the tangential velocity 120vₜ is a first percentage of the linear velocity 50v.

Roller 120 contacts one side of medium material 50 and applies moisture to the side of 50 in contact with the surface of roller 120. A contact location 121 is positioned where a portion of the outer surface of the moisture applicator roll 120 contacts a portion of a flowing web of paper material 50 at a linear velocity 50v. A tangent direction of roll 120 at contact location 121 is substantially opposite flow F. The tangential velocity 120vₜ of the roll 120 opposes the direction of flow at the contact location or point 121. While the shown embodiment discloses one moisture application roller 120, clearly a second moisture application roller positioned on the opposite side of sheet 50 from first roller 120 is possible to dually pre-wet sheet 50 from each side.

A moisture metering device 130 is positioned closely adjacent the outer surface of applicator roller 120 to apply a thin film of liquid or moisture 132 (FIG. 4B) to outer surface of roller 120. The thin film of liquid 132 can include any or all of water, adhesives, additives, and/or other liquids which may have various solids or gases contained therein. For clarity, the following examples used throughout herein will be described with reference to liquid being water though it is entirely possible that other fluid combinations may be used. Metering device 130 includes a rod assembly 134 containing an elongated cylindrical shaft 136 wrapped or circumscribed by threads 138. Rod 136 is positioned along an axis parallel to axis of applicator roller 120. In some embodiments rod 136 may be fixed and in another embodiment rod 136 may rotate about its axis. In the rotatable embodiment, each end of rod 136 may be connected to device 130 via a plurality of bearings to allow rod 136 to rotate about its axis. Additionally rod 136 may connect to the frame for securing rod adjacent roller 120. Metering device 130 may further include a liquid storage chamber or liquid source 140 in fluid communication with grooves 142. Grooves 142 are defined by the convex outer surface of threads 138. Groove 142, when viewed in cross-section (FIG. 4B), forms continuous but non-linear voids for carrying and transferring water to surface of applicator roll 120. Additionally, other conventionally known metering rod devices comprising elements such as various channels or fluid pressure members to drive water or fluid towards channel 142 are clearly impossible. When such bladder driven fluid pressure devices are used, pressure may be continuous and uniform along the entire length of the metering rod, or clearly it may be semi-continuous and non-uniform if preferred for a certain application.

Rod 136 is connected to the frame 58 such that rod 136 does not deflect up nor down as a result of the hydrostatic pressure with respect to rotating roller 120. Rod 136 remains substantially parallel and in the same plane during operation. Therefore, rod 136 produces a uniform thickness or coating of liquid on outer circumferential surface of roller 120 moving at tangential velocity 120vₜ opposite the direction of flow F.

The sheet of medium material 50 flows F along the sheet material pathway at a linear velocity 50v. There are a series of speed threshold ranges (FIG. 11; 602, 604, 606, 608, 610), wherein the linear velocity of the flowing F medium material 50 is within one of the threshold ranges, the ranges defining a numerical boundary for the percentage amount of the tangential velocity 120vₜ of the applicator roll 120, thereby determining the amount metered liquid applied to the applicator roll 120 and thus available to be transferred to material 50. The speed threshold ranges form a stepwise graph function (FIG. 11) such that the tangential velocity 120vₜ of the applicator roll 120 is the same percentage of the material linear velocity for the any linear material velocity within a respective step of the stepwise graph function. A series of tangential velocity 120vₜ percentage step-values (FIG. 11) exist for all values within a given threshold range. The amount of liquid metered onto the applicator roll 120 depends on the angular velocity of the applicator roll 120, as well as the gap defined between rod 136 and outer surface of roll 120. Linear velocity 50v is preferably measured downstream from double backer 500 (FIG. 3) by a speed measuring device mounted adjacent the material pathway. However, it is clearly contemplated that the speed measuring device may be mounted in other locations for measuring line speed 50v to determine tangential velocity 120vₜ of the applicator roll 120.

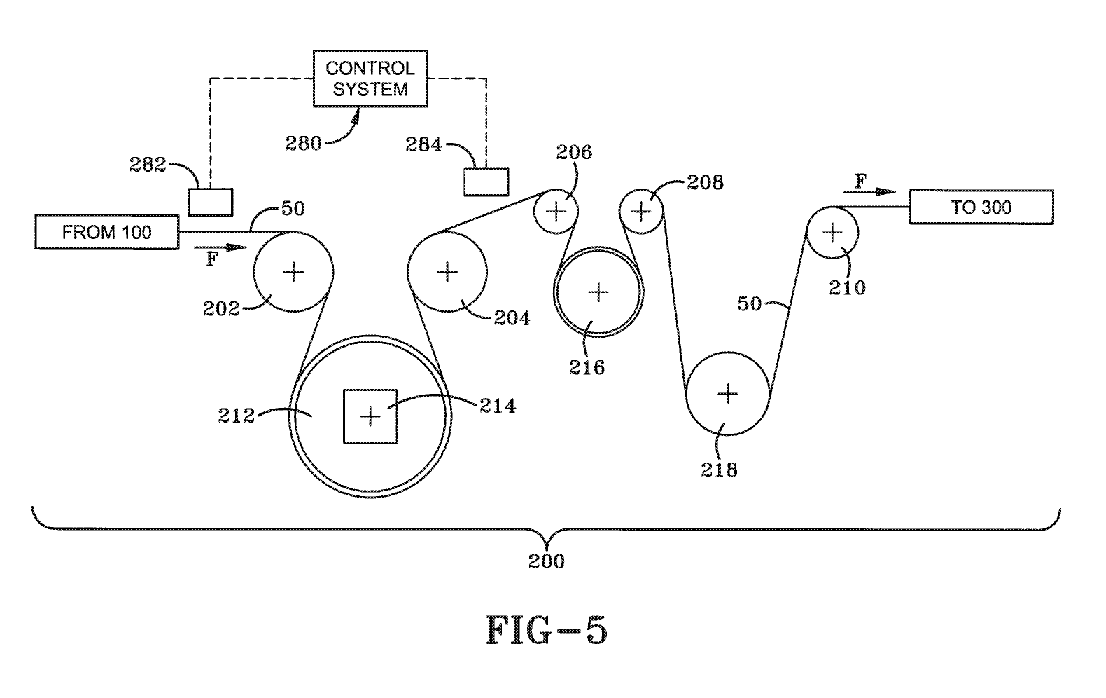

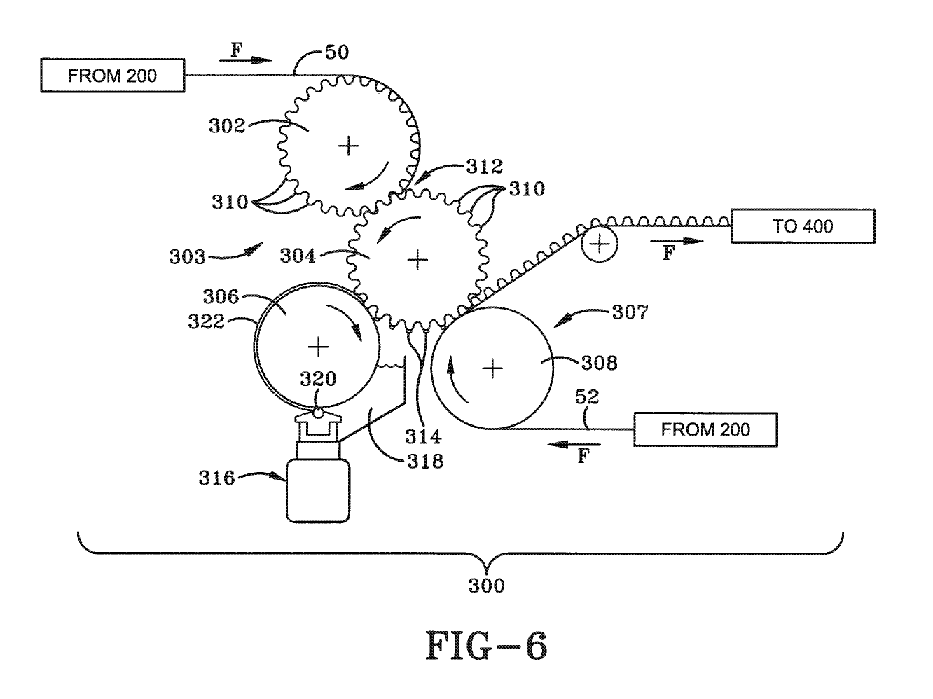

With primary reference to FIG. 5, a web heating arrangement 200 includes a plurality of idle rollers 202, 204, 206, 208, 210 each connected to the frame 58 and rotating about a respective axis all of which extend laterally and substantially perpendicular to the flow direction F of sheet material 50 along the pathway. Heating arrangement 200 further includes heating roll 212 operatively connected to a heat source 214, a first drive roller 216 and a second drive roller 218. Heat source 214 is contemplated being a compressed steam system as conventionally understood in the art. The compressed steam (“steam” refers to water is its gaseous state) in heat source 214 increases in temperature as more pressure is imparted into the steam. Steam produced from source 214 is in communication with heat roll 212 and preferably contained therein. The steam contained in roll 212 imparts a temperature to the outer surface of the roll 212 through conductive, radiant, or convective heat transfer. Clearly, additional types of heating device used to heat rollers in similar paperboard manufacturing processes may be substituted for the compressed steam system heating.

Steam temperature pressure tables are well known in the art. Pressurized or compressed steam tables indicate the gauge pressure of steam, in pounds per square inch (psi), and the corresponding temperature of the saturated steam. An exemplary Steam Temperature Pressure Table is provided below in Table 1:

TABLE 1

| Pressure | Corresponding temperature of |
|---|---|
| of Steam (in psi) | saturated/pressurized steam (in ° F.) |
| 0 | 212 |
| 50 | 298 |
| 70 | 316 |
| 75 | 320 |
| 80 | 324 |
| 85 | 328 |
| 90 | 331 |
| 95 | 335 |
| 100 | 338 |
| 105 | 341 |
| 110 | 344 |
| 115 | 347 |
| 120 | 350 |
| 130 | 355 |
| 140 | 361 |
| 150 | 366 |
| 175 | 377 |
| 200 | 388 |

Each of the rolls 202, 204, 206, 208, 210, 212, 214, 216, and 218 respectively define a portion of the sheet material pathway along which material 50 flows F downstream from the pre-wetting apparatus 100 towards the corrugator 300. Heating arrangement 200 further includes a moisture control system 280 electronically connected to one or more moisture measurement devices 282, 284. Control system 280 is configured to provide a closed loop control of moisture measuring system in the web 50 flowing downstream. The moisture measurement device 280 can measure moisture in the paper web 50 before and after paper is heated by roll 212 of heating arrangement 200. Control system 280 may contain computer logic software or other integrated software to operate free from human monitoring.

Rollers 202 and 204 are preferably positioned above heat roller 212. When viewed from the side (as in FIG. 5), material 50 forms a U-shape pathway between rollers 202, 204 and heat roller 212. Idle rollers 206 and 208 are positioned downstream from heat roller 212. Rollers 206 and 208 are positioned above drive roller 216 and form a second U-shaped pathway therewith. Second drive roller 218 and idle roller 210 are positioned downstream from idle roller 208 and form a third U-shaped pathway therewith.

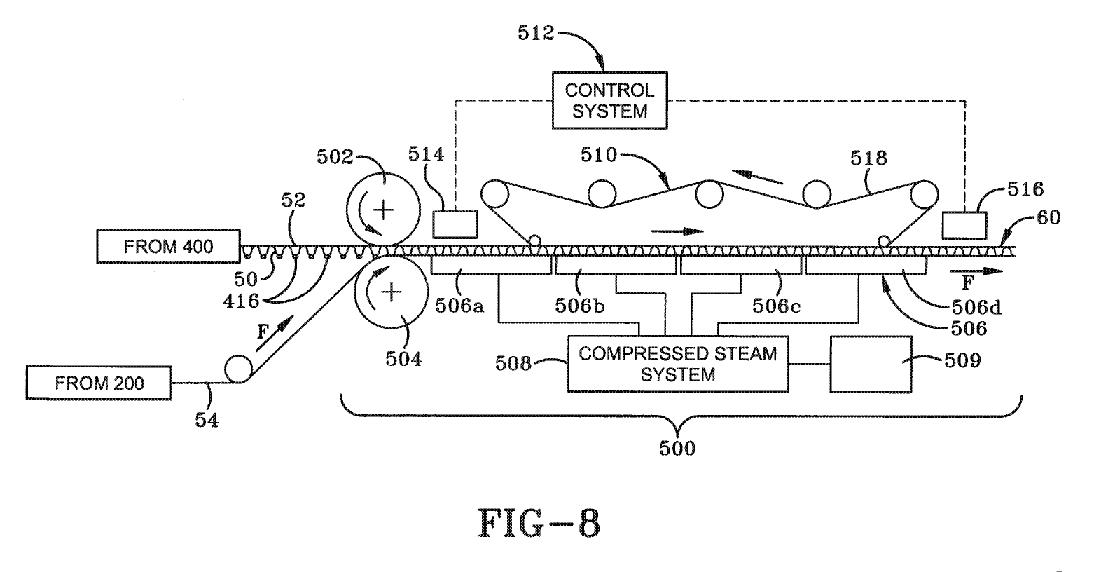

Preferably, and with continued reference to heating apparatus 200, when the medium material 50 (FIG. 5) flows F through heating device 200, material 50 is preferably heated to a temperature is in a range from 150 degrees Fahrenheit to 170 degrees Fahrenheit. When first liner 52 traverses through heating device 200 (FIG. 6; liner 52 flowing “FROM 200”), liner 52 is heated to a temperature in a range from about 185 degrees Fahrenheit to about 205 degrees Fahrenheit. Providing medium 50 at a lower temperature than liner 52 provides unexpected results that reduce warping and produce a flatter paperboard 60. Further, second liner 54 (FIG. 8; second liner 54 flowing “FROM 200”) is heated to a temperature up to but not exceeding about 130 degrees Fahrenheit, and is preferably heated to a temperature of 120 degrees Fahrenheit. Further, when producing a “double-backed” sheet of paperboard 60, providing the second liner 54 at a temperature less than medium 50 and first liner 52 provides unexpected results that reduce warping and produce a flatter paperboard 60.

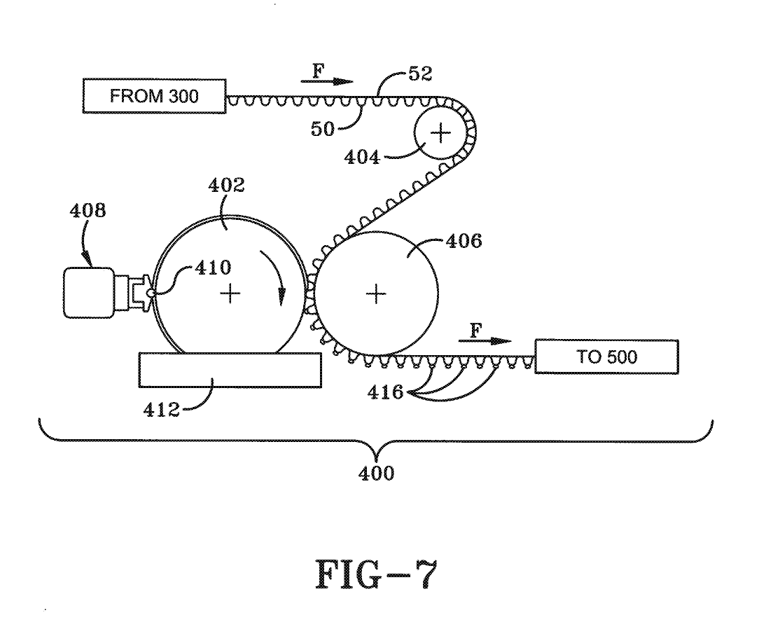

As shown in FIG. 7, single facer machine 300 includes a first corrugating roller 302, a second corrugating roller 304, an adhesive roller 306, and a single facing roller 308. Corrugating rollers 302, 304 define a portion of a corrugating device 303. Single facing roller 308 and corrugating roller 304 define a portion of a paperboard facing device 307. First and second corrugating rollers 302, 304 are connected to frame 58 and extend laterally and substantially perpendicular to flow direction F of material 50 and define a portion of the sheet material pathway. Each of first and second corrugating rollers 302, 304 include a plurality of teeth 310 that cooperate to nestingly fit in a series of complimentary peaks and valleys. The respective complimentary peaks and valleys of teeth 310 of each roller 302, 304 meet at a corrugating nip 312. Nip 312 therethrough defines a portion of the sheet material pathway. Material 50 flows through nip 312 and is corrugated into a sinusoidal shape by cooperating complimentary teeth 310 of rollers 302, 304. Roller 302 rotates about its axis in the same direction as flow F. Similarly, roller 304 rotates about its axis in the same direction as flow F.

Adhesive roller 306 is positioned closely adjacent corrugating roller 304. Adhesive roller 306 contacts corrugated sheet 50 at the peaks to deposit a bead of adhesive 314 thereon. Adhesive roller 306 cooperates with an adhesive metering device 316 and an adhesive source 318. Adhesive metering device 316 includes a metering rod 320. Adhesive metering rod 320 includes similar threaded features as metering device 134 to meter the amount of adhesive rotatably applied to outer surface of roll 306. As in metering device 134, the metering rod 320 is adjustable to move towards or away from the outer surface of roll 306 to precisely set the gap therebetween. When the gap is set to near contact such that rod 320 is in near contact with applicator roll 306, nearly all the adhesive is removed from the outer surface of roll 306, excluding the adhesive 322 that passes through the channels 142 defined by threads 138. Rod 320 may be adjusted for form a larger gap to allow nearly all adhesive to remain on the outer surface of rod 320.

Single facing roller 308 is in communication with a heat source 315. Heat source 315 is preferably a compressed or pressurized steam device. Heat source 315 drives compressed steam into roller 308 in order to heat roller 308. Heat source 315 may be connected to heat source 214, or may be its own independent unit. As explained supra, the compressed steam pressure has an associated temperature, and thus heats up roll 308 containing the pressurized steam therein. The pressurized steam in communication with roll 308 should be less than 175 psi, and preferably is 150 psi. Steam in communication with roll pressurized at 150 psi imparts a temperature of about 365° F. to roll 308. Roll 308 should not be heated to a temperature greater than 377° F. (the temperature of steam compressed to 175 psi).

With primary reference to FIG. 7, glue machine 400 includes an adhesive roll applicator 402, a first roller 404, and a second roller 406, an adhesive metering device 408 having a metering rod 410, and an adhesive source 412. First and second rollers 404, 406 define a portion of the sheet material pathway. Applicator 402 defines a portion of the sheet material pathway and is positioned substantially perpendicular to flow direction F. Applicator 402 is centered and rotates about an axis causing outer surface of applicator 402 to move in the same direction as flow F. Meter rod 410 is substantially similar to metering rod 320 and likewise adjustable as previously described herein supra to meter an amount of adhesive from source 412 to create an amount of surface adhesive 414. Adhesive applicator 402 is positioned closely adjacent roll 406 such that adhesive 414 on the outer surface of roll 402 contacts the corrugated flutes to deposit a bead of adhesive 416 on the flutes opposite where bead 318 attaches liner 52 to medium 50.

As shown in FIG. 8, double backer 500 includes a first roller 502, a second roller 504, a plurality of hot plates 506 operatively connected to a plate temperature (or pressurized steam) control system 508, a drive system 510, and a monitoring control system 512. Double backer 500 is configured to attach second liner 54 to corrugated medium 50 via adhesive bead 416. Double backer 500 is further configured to uniformly cool medium and liner material as the drive system 510 moves the formed paperboard 60 over hot plates 506. Hot plates 506 cooperate to define a bottom boundary of the flow stream F and sheet material pathway.

First roller 502 is positioned vertically above second roller 504 defining a gap therebetween. Sheet material pathway flows through and is partially defined by the gap. Rollers 502, 504 rotate about their respective axes such that the outer surface moves in the direction of the flow stream F. A pressure exerting device may be present to import an amount of pressure between material 50 and second liner 54 at bead 416. Second liner 54 is pre-conditioned in 100 and heated in heating apparatus 200 (to a temperature not exceeding 130° F., and preferably 120° F.) prior to being fed into double backer 500.

Control system 508 is in communication with a heat source 509. Heat source 509 may be an independent system or it can be in communication with heat sources 214 and 315. Preferably, Heat sources 509, 214, and 315 are derived from one pressurized steam generator. Control system 508 regulates the amount of pressurized steam driven to each respective plate within the set of hot plates 506. Further, plates 506 define a storage chamber or passageway for containing pressurized steam therein. Similar to the heating rolls, the pressurized steam containment chamber within plates 506 imparts or transfers a desired temperature to the outer surface of the hot plates 506.

In a preferred embodiment of present invention 1000, hot plates 506 vary in temperature to cool and cure the adhesive. While not necessarily intuitive at first, the inventors have found that this non-uniform temperature hot plate arrangement actually encourages uniform evaporation from material 50, 52, 54, to create paperboard 60 that is free from any warping. This arrangement has yielded fascinating and unexpected results over similar machines, such as the Kohler device identified in U.S. Pat. No. 8,398,802 and discussed supra in the Background Section. These prior art devices tend to use hot plates at temperatures exceeding 330° F. These temperatures tend to cause more steam to flash from the drying paperboard 60, which can often lead to non-uniform evaporation. Hot plates 506 of the present invention are preferably all near or below 330° F. to reduce or even prevent the uneven flashing evaporation of steam leaving the paperboard 60.

Two hot plates 506 may have a same temperature. Preferably, there are at least four hot plates 506a, 506b, 506c, 506d arranged side-to-side from upstream to downstream, wherein the hot plate with the lowest temperature is positioned in the most upstream position of the four plates as in 506a. In this arrangement the temperature of each plate does not decrease relative to the other plates from the upstream position to the downstream position. So by way of non-limiting example, a first plate 506a is positioned in the most upstream position relative to the other hot plates 506, having a temperature in a range from 312° F. to 320° F. (heated with pressurized steam at 65 psi to 75 psi); a second plate 506b is positioned downstream from the first plate 506a having a temperature in a range from 320° F. to 328° F. (heated with pressurized steam at 75 psi to 85 psi); a third plate 506c is positioned downstream from the second plate 506b having a temperature in a range from 320° F. to 328° F. (heated with pressurized steam at 75 psi to 85 psi); and a fourth plate 506d is position downstream from the third plate 506c having a temperature in a range from 328° F. to 333° F. (heated with pressurized steam at 85 psi to 95 psi). Further preferably, additional embodiments include wherein no hot plate 506 has a temperature exceeding about 330° F. (heated with pressurized steam at 90 psi). More specifically, the first hot plate 506a temperature is 316° F. (heated with pressurized steam at 70 psi), the second hot plate 506b is 324° F. (heated with pressurized steam at 80 psi), the third hot plate is 324° F. (heated with pressurized steam at 80 psi), and the fourth hot plate is 330° F. (heated with pressurized steam at 90 psi). These temperatures are controlled by temperature control system 508 operatively connected to each respective plate 506. Control system 508 may contain computer logic software or other integrated software to operate free from human monitoring.

One or more moisture measurement devices 514, 516 and corresponding control system 512 can be used for one or all materials 50, 52, 54 to be heated to provide a closed loop control of moisture in each individual sheet of material 50, 52, 54 that make up completed paperboard 60. Further, drive system 510 may include a plurality of drive rollers to move a belt 518 in a loop to move formed paperboard 60 over hot plates 506. Control system 512 may contain computer logic software or other integrated software to operate free from human monitoring.

The term “logic”, as used herein, with reference to control systems 280 (FIG. 5), refers to and includes but is not limited to hardware, firmware, software and/or combinations of each to perform a function(s) or an action(s), and/or to cause a function or action from another logic, method, and/or system. For example, based on a desired application or needs, logic may include a software controlled microprocessor, discrete logic like a processor (e.g., microprocessor), an application specific integrated circuit (ASIC), a programmed logic device, a memory device containing instructions, an electric device having a device to read a software medium, or the like. Logic may include one or more gates, combinations of gates, or other circuit components. Logic may also be fully embodied as software. Where multiple logics are described, it may be possible to incorporate the multiple logics into one physical logic. Similarly, where a single logic is described, it may be possible to distribute that single logic between multiple physical logics.

As shown in FIG. 10, paperboard 60 upon exiting double backer 500 dries at an even rate and contains no warping when viewed from the side. The term no warping refers to a sheet of manufactured paperboard 60 that is substantially flat and planar with no deflection upwardly or downwardly. As shown in FIG. 11, paperboard 60 further has even and uniform adhesive lines which form a proper lamination between components 50, 52, 54 which make up paperboard sheet 60.

As briefly described above, and with further reference to FIG. 11, a step-wise graph 600 is provided depicting a series of speed threshold ranges and a series of tangential velocity percentage step-values. Graph 600 plots the tangential velocity 120vₜ of an applicator roll on the y-axis versus the linear velocity 50v of a sheet of traveling web material. There are a series of speed threshold ranges, wherein the linear velocity 50v of the flowing F medium material 50 is within one of the threshold ranges. The speed threshold ranges and the tangential velocity percentage step-values form a stepwise graph function (FIG. 11) such that the tangential velocity 120vₜ of the applicator roll 120 is the same percentage of the material linear velocity for the any linear material velocity within a respective step of the stepwise graph function.

By way of non-limiting example, preferably there are five ranges within this set of speed threshold ranges. A first speed threshold range 602 represents a linear velocity 50v of material 50 flowing from 1 feet per minute (fpm) to 100 fpm. When material 50 is flowing at any speed 50v within the first range 602, the tangential velocity 120vₜ of applicator roll 120 is equal to 100% of linear material speed 50v. Thus, if web speed 50v is equal to 50 fpm, then tangential velocity 120vₜ is equal 50 fpm. A second threshold range 604 represents a linear velocity 50v of material 50 flowing from 100 fpm to 300 fpm. When material 50 is flowing at any speed 50v within second range 604, the tangential velocity 120vₜ of applicator roll 120 is equal to 80% of linear material speed 50v. Thus, if web speed 50v is equal to 200 fpm, then tangential velocity 120vₜ is equal 160 fpm. A third threshold range 606 represents a linear velocity 50v of material 50 flowing from 300 fpm to 500 fpm. When material 50 is flowing at any speed 50v within third range 606, the tangential velocity 120vₜ of applicator roll 120 is equal to 70% of linear material speed 50v. Thus, if web speed 50v is equal to 400 fpm, then tangential velocity 120vₜ is equal 280 fpm.

A fourth threshold range 604 represents a linear velocity 50v of material 50 flowing from 500 fpm to 800 fpm. When material 50 is flowing at any speed 50v within fourth range 608, the tangential velocity 120vₜ of applicator roll 120 is equal to 55% of linear material speed 50v. Thus, if web speed 50v is equal to 600 fpm, then tangential velocity 120vₜ is equal 330 fpm. A fifth threshold range 610 represents a linear velocity 50v of material 50 flowing faster than 801 fpm. When material 50 is flowing at any speed 50v within fifth range 610, the tangential velocity 120vₜ of applicator roll 120 is equal to 45% of linear material speed 50v. Thus, if web speed 50v is equal to 1000 fpm, then tangential velocity 120vₜ is equal 450 fpm.

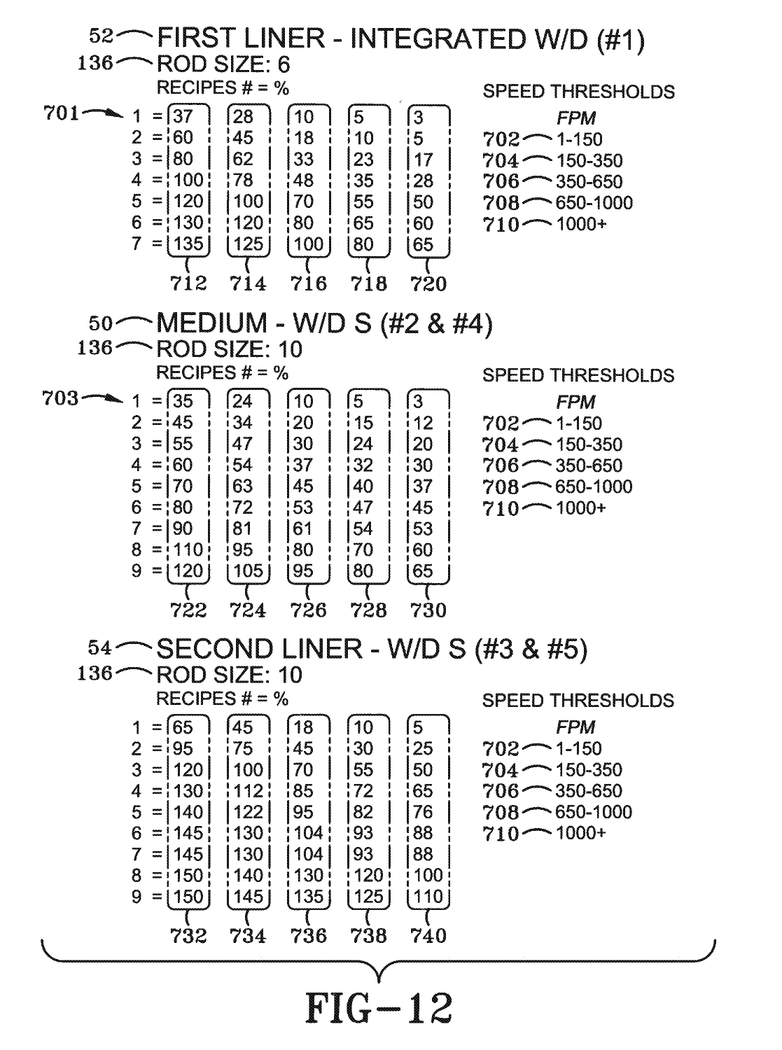

With primary reference to FIG. 12, an additional exemplary set of speed threshold ranges of the linear velocity 50v of material 50 flowing F along the sheet material pathway include a first range 702 from about 1 foot per minute (FPM) to about 150 FPM; a second range 704 from about 150 FPM to about 350 FPM; a third range 706 from about 350 FPM to about 650 FPM; a fourth range 708 from about 650 FPM to about 1000 FPM; a fifth range 710 from about 1000 FPM to all speeds there beyond exceeding 1000 FPM. When system 1000 is operational the linear velocity 50v of the flowing F medium material 50 is within one of the first, second, third, fourth, and fifth ranges. A series of tangential velocity 120vₜ percentage step-values exist that correspond to the speed threshold ranges. The tangential velocity 120vₜ step values may be in a range from 20% to about 80%; from 20% to about 70%; from 20% to about 55%; from 20% to about 45%; from 20% to about 35%, when the linear velocity 50v is within one of the threshold ranges. Further, the threshold ranges may also be known as sub-ranges. So for example if the entire range is from 1 FPM to 1000+FPM, then the respective thresholds can also be sub-ranges of the entire range.

By way of non-limiting example, in a first recipe 701, if a metering rod 136 is a size 6 metering rod as one would understand in the art, then when the linear velocity 50v of the flowing first liner 52 is within the first range 702, the tangential velocity 120vₜ of the applicator roll 120 is about 40% to about 30%, specifically 37%, of the linear velocity 50v of the flowing first liner 52. When the linear velocity 50v of the flowing first liner 52 is within the second range 704, the tangential velocity 120vₜ of the applicator roll 120 is about 30% to about 20%, specifically 28%, of the linear velocity 50v of the flowing first liner 52. When the linear velocity 50v of the flowing liner 52 is within the third range 706, the tangential velocity 120vₜ of the applicator roll 120 is about 20% to about 7%, specifically 10%, of the linear velocity 50v of the flowing liner 52. When the linear velocity 50v of the flowing liner 52 is within the fourth range 708, the tangential velocity 120vₜ of the applicator roll 120 is about 7% to about 4%, specifically 5%, of the linear velocity 50v of the flowing liner 52. And, when the linear velocity 50v of the flowing F liner 52 is within the fifth range 710, the tangential velocity 120vₜ of the applicator roll 120 is about 4% to about 2%, specifically 3%, of the linear velocity 50v of the flowing liner 52.

By way of an additional non-limiting example, in a second recipe 703, if metering rod 136 is a size 10 as one in the art would understand, then when the linear velocity 50v of the flowing medium material 50 is within the first range 702, the tangential velocity 120vₜ of the applicator roll 120 is about 40% to about 30%, specifically 35%, of the linear velocity 50v of the flowing medium material 50. When the linear velocity 50v of the flowing material 50 is within the second range 704, the tangential velocity 120vₜ of the applicator roll 120 is about 30% to about 20%, specifically 24%, of the linear velocity 50v of the flowing medium material 50. When the linear velocity 50v of the flowing material is within the third range 706, the tangential velocity 120vₜ of the applicator roll 120 is about 20% to about 7%, specifically 10%, of the linear velocity 50v of the flowing medium material 50. When the linear velocity 50v of the flowing material is within the fourth range 708, the tangential velocity 120vₜ of the applicator roll 120 rotates is about 7% to about 4%, specifically 5%, of the linear velocity 50v of the flowing medium material 50. And, when the linear velocity 50v of the flowing material is within the fifth range 710, the tangential velocity 120vₜ of the applicator roll 120 is about 4% to about 2%, specifically 3%, of the linear velocity 50v of the flowing medium material 50.

In operation and with primary reference to FIG. 5, a web of medium material 50 is fed into the medium conditioning apparatus 100 from a source 102, preferably a paper roll for making paperboard or cardboard as is commonly known in the art. Upon entering the medium conditioning apparatus 100, material 50 can be first fed through a pre-tensioning mechanism 110 and then passed through a pre-wetting moisture application roller 120. Moisture application roller 120 contacts and applies liquid or moisture to the medium material 50 to adjust its moisture content in a desired range prior to exiting apparatus 100.

Some exemplary moisture ranges claimed in the Kohler '802 patent are in the range of 6-9% wt. System 1000 can operate outside of these moisture ranges when necessary, either lower than 6% wt. or higher than 9% wt. For example, when material 50 is flowing F, roll 120 is configured to apply or otherwise impart a moisture content into material 50 in the range of 10-18% wt. Additionally, if either liner 52 or second liner 54 is flowing F through conditioning apparatus 100, roll 120 is configured to impart a moisture content in the range of 32-42% wt into liner 52 or second liner 54.

In operation and with continued reference to the moisture applicator roller 120 (FIG. 5) and FIG. 11, when the flowing F linear velocity 50v of material 50 is plotted against the tangential velocity 120vₜ a value exists indicating the tangential velocity percentage in a threshold range. While a previously given example provided alternative threshold ranges, the following ranges are also contemplated. When the medium material 50 is flowing F within a first threshold range 602 from about 1 foot per minute (FPM) to about 100 FPM, the tangential velocity 120vₜ of the outer surface of the applicator roll 120 is about 100% of the linear velocity of the medium material 50. When the medium material 50 is flowing within a second threshold range 604 from about 100 FPM to about 300 FPM, the tangential velocity 120vₜ of the outer surface of the applicator roll 120 is about 80% of the linear velocity of the medium material 50. When the medium material 50 is flowing within a third threshold range 606 from about 300 FPM to about 500 FPM, the tangential velocity 120vₜ of the outer surface of the applicator roll 120 is about 70% of the linear velocity of the medium material 50. When the medium material 50 is flowing within a fourth threshold range 608 from about 500 FPM to about 800 FPM, the tangential velocity 120vₜ of the outer surface of the applicator roll 120 is about 55% of the linear velocity of the medium material 50. And, when the medium material is flowing within a fifth threshold range 610 from about 800 FPM and faster, the tangential velocity 120vₜ of the outer surface of the applicator roll 120 is about 45% of the linear velocity of the medium material.

It is further to be understood that first liner 52 is pre-conditioned or pre-wetted in a manner similar to medium material 50. For example, with reference to FIG. 7 and FIG. 12 where liner 52 flows “FROM 200” a sheet of liner material 52 flows along a liner material pathway at a linear velocity, and configured to adhere to a first fluted side of the corrugated medium material 50. A second applicator roll, similar to roll 120, rotatably connected to the frame and positioned adjacent the liner material pathway and upstream from where the liner material is adhered to the corrugated medium material at 314 along the liner material pathway. The second applicator roll is configured to apply a liquid to the flowing liner material 52. The second applicator roll has a length and a radius, wherein the second applicator roll rotates about a second axis at an angular velocity, and wherein an outer surface of the second applicator roll travels at a tangential velocity as the second applicator roll rotates. The second applicator roll transfers the liquid to the sheet of liner material 52 as the liner 52 flows by and adjacent the second applicator roll along the liner material pathway. A second metering device, similar to 130, adjacent the second applicator roll meters an amount of the liquid onto the second applicator roll. Similar to 120 and 130, the amount of liquid metered onto the second applicator roll depends on the angular velocity and the gap defined between the metering rod and the second applicator roll. Further, the tangential velocity of the second applicator roll is a percentage of the linear velocity of the flowing liner material 52.

Additionally, a second series of speed threshold ranges exist, the second threshold ranges defining a numerical boundary for a percentage amount of the tangential velocity of the second applicator roll relative to the linear velocity of the liner material 52, thereby determining the amount metered liquid applied to the second applicator roll, the ranges including: a first range 702 from about 1 foot per minute (FPM) to about 150 FPM; a second range 704 from about 150 FPM to about 350 FPM; a third range 706 from about 350 FPM to about 650 FPM; a fourth range 708 from about 650 FPM to about 1000 FPM; and a fifth range 710 from about 1000 FPM and beyond. The linear velocity of the flowing liner material 52 is within one of the first, second, third, fourth, and fifth ranges. The speed thresholds form a stepwise graph function such that the tangential velocity of the second applicator roll is the same for any liner velocity within a respective step of the stepwise graph function.

For any recipe one through seven (FIG. 12) when the linear velocity of the flowing liner material 52 is within the first range 702, the tangential velocity of the second applicator roll is about 140% to about 30% of the linear velocity of the flowing liner material 52, shown as 712. When the linear velocity of the flowing liner material 52 is within the second range 704, the tangential velocity of the second applicator roll is about 130% to about 15% of the linear velocity of the flowing liner material 52, shown as 714. When the linear velocity of the flowing liner material 52 is within the third range 706, the tangential velocity of the second applicator roll is about 110% to about 7% of the linear velocity of the flowing liner material 52, shown as 716. When the linear velocity of the flowing liner material 52 is within the fourth range 708, the tangential velocity of the second applicator roll is about 90% to about 4% of the linear velocity of the flowing liner material 52, shown as 718. When the linear velocity of the flowing liner material 52 is within the fifth range 710, the tangential velocity of the second applicator roll is about 75% to about 2% of the linear velocity of the flowing liner material 52, shown as 720.

Additionally when the first liner 52 is flowing, the second applicator roll may have a second tangential velocity percentage range from 35% to about 55%; from 55% to about 75%; from 75% to about 95%; from 95% to about 115%; from 115% to about 135%; and from 135% to about 155%, of the flowing first liner 52.

Further, for any recipe one through seven (FIG. 12) when the linear velocity of the flowing medium material 50 is within the first range 702, the tangential velocity of the first applicator roll 120 is about 130% to about 30% of the linear velocity of the flowing medium material 50, shown as 722. When the linear velocity of the flowing medium material 50 is within the second range 704, the tangential velocity of the first applicator roll 120 is about 110% to about 20% of the linear velocity of the flowing medium material 50, shown as 724. When the linear velocity of the flowing medium material 50 is within the third range 706, the tangential velocity of the first applicator roll 120 is about 100% to about 7% of the linear velocity of the flowing medium material 50, shown as 726. When the linear velocity of the flowing medium material 50 is within the fourth range 708, the tangential velocity of the first applicator roll 120 is about 85% to about 4% of the linear velocity of the flowing medium material 50, shown as 728. When the linear velocity of the flowing medium material 50 is within the fifth range 710, the tangential velocity of the first applicator roll 120 is about 70% to about 2% of the linear velocity of the flowing medium material, shown as 730.

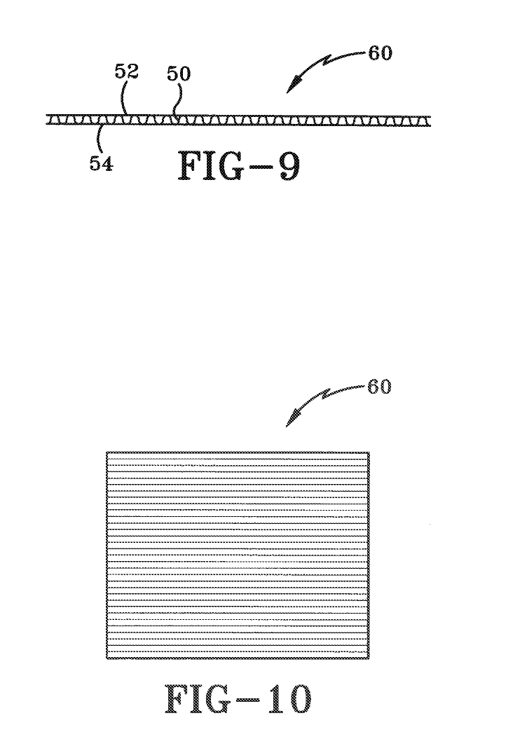

It is further to be understood that second liner 54 is pre-conditioned or pre-wetted in a manner similar to medium material 50. For example, with primary reference to FIG. 9 and FIG. 12 where second liner 54 flows “FROM 200” the sheet of second liner material 54 flows along a second liner material pathway at a linear velocity, and configured to adhere to the corrugated medium material 50 along a second fluted side opposite the first liner material at bead 416. A third applicator roll, similar to 120, is rotatably connected to the frame and positioned adjacent the second liner material pathway and upstream from where the second liner material 54 is adhered at 314 to the corrugated medium material 50 along the second liner material pathway, wherein the third applicator roll is configured to apply a liquid to the flowing second liner material and the third applicator roll having a length and a radius. The third applicator roll rotates about a third axis at an angular velocity, and wherein an outer surface of the third applicator roll travels at a tangential velocity as the third applicator roll rotates. The third applicator roll transfers the liquid to the sheet of second liner 54 material as the liner 54 flows by and adjacent the third applicator roll along the liner material pathway. A third metering device, similar to 130, adjacent the third applicator roll meters an amount of the liquid onto the third applicator roll. The amount of liquid metered onto the third applicator roll depends on the angular velocity of the third applicator roll. The tangential velocity of the third applicator roll is a percentage of the linear velocity of the flowing second liner material 54.

With continued reference to the third applicator roll and FIG. 12, a third series of speed threshold ranges exist, the ranges defining a numerical boundary for a percentage amount of the tangential velocity of the third applicator roll relative to the linear velocity of the second liner material 54, thereby determining the amount metered liquid applied to the third applicator roll, the ranges including: a first range 702 from about 1 foot per minute (FPM) to about 150 FPM; a second range 704 from about 150 FPM to about 350 FPM; a third range 706 from about 350 FPM to about 650 FPM; a fourth range 708 from about 650 FPM to about 1000 FPM; and a fifth range 710 from about 1000 FPM and faster. The linear velocity of the flowing second liner material 54 is within one of the first, second, third, fourth, and fifth ranges. The speed thresholds form a stepwise graph function such that the tangential velocity of the third applicator roll is the same for any second liner 54 velocity within a respective step of the stepwise graph function.

When the linear velocity of the flowing second liner material 54 is within the first range 702, the tangential velocity of the third applicator roll is about 160% to about 60% of the linear velocity of the flowing second liner material 54, shown as 732. When the linear velocity of the flowing second liner material 54 is within the second range 704, the tangential velocity of the third applicator roll is about 150% to about 40% of the linear velocity of the flowing second liner material 54, shown as 734. When the linear velocity of the flowing second liner material 54 is within the third range 706, the tangential velocity of the third applicator roll is about 140% to about 13% of the linear velocity of the flowing second liner material 54, shown as 736. When the linear velocity of the flowing second liner material 54 is within the fourth range 708, the tangential velocity of the third applicator roll is about 130% to about 5% of the linear velocity of the flowing second liner material 54, shown as 738. And, when the linear velocity of the flowing second liner material 54 is within the fifth range 710, the tangential velocity of the third applicator roll is about 115% to about 1% of the linear velocity of the flowing second liner material 54, shown as 740.

Additionally when the second liner 54 is flowing, the third applicator roll may have a third tangential velocity percentage range from 35% to about 55%; from 55% to about 75%; from 75% to about 95%; from 95% to about 115%; from 115% to about 135%; and from 135% to about 155%, of the flowing second liner 54.

In operation and with primary reference to FIG. 6, idle roller 202 directs or guides sheet material 50 towards heat roll 212. Outer surface of heat roll 212 contacts sheet material 50 as material 50 flows circumferentially around and along outer surface of heat roll 212 making substantial contact therewith. The amount of time sheet material 50 is in contact with the outer surface of heat roll 212 is known as the dwell time. Dwell time may be increased or decreased depending on the amount of heat desired to be transferred to paper web 50. As briefly detailed above, if medium material 50 is flowing over heat roll 212, medium 50 is heated to a temperature in a range from 150 degrees Fahrenheit to 170 degrees Fahrenheit (as shown in FIG. 6; 50 flowing F “FROM 200”). If first liner 52 is flowing over heat roll 212, first liner 52 is heated to a temperature in a range from about 185 degrees Fahrenheit to about 205 degrees Fahrenheit (as shown in FIG. 6; 52 flowing F “FROM 200”). If second liner 54 is flowing F over heat roll 212, second liner 54 is heated to a temperature up to but not exceeding about 130 degrees Fahrenheit (as shown in FIG. 8; 54 flowing F “FROM 200”).

Web 50 exits and leaves heat roll 212 passing along, over and around various idle rollers, shown as 204, 206 towards drive roller 216. Drive roller 216 is preferably a suction roller as known and understood in the art. Suction roller 216 has a perforated outer surface to create a linear tension on web 50 as it travels downstream. A zero contact drive roller 218 is positioned between idle rollers 208 and 210. Zero contact roll 218 can be a stationary roller that does not rotate as the web of material traverses its circumferential surface. Instead, a volumetric flow rate of air at a controlled pressure is pumped from within the zero contact roll 218 radially outward through small openings or holes provided periodically and uniformly over and through the outer circumferential wall of the zero contact roll 218. The passing web of medium material 50 is supported by the circumferential outer surface of the zero contact roll 218 by a cushion of air.

In operation, and with primary reference to FIG. 6, the flowing material 50 flows along the sheet material pathway in the direction of arrow F. Material 50 flows around the outer surface of corrugating roller 302. Material 50 flows through nip 312 where it begins to be corrugated. The complimentary peaks of teeth 310 on roller 302 and valleys of teeth 310 of roller 304 interlock to sandwich material 50 therebetween. The interlocking teeth form the sinusoidal shape of material 50. Material 50 continues to move downstream towards the adhesive application roller 306.

Adhesive application roller 306 rotates about its axis into a pool 318 of adhesive. The pool 318 is in contact with outer surface of roller 306. As roller 306 rotates, adhesive is metered (metered adhesive 322) by metering rod 320 onto the outer surface of roll 306. Metered adhesive 322 is a precise amount and can specifically vary depending on each desired application by adjusting rod 320 relative to surface of roll 306. The amount of metered adhesive 322 determines the thickness or amount of adhesive bead 314 applied to the flute tip of corrugated sheet 50.

Corrugated sheet 50 having bead of adhesive 314 moves towards roll 308. Roll 308 receives a first liner 52 from a feed source or from heating device 200. Material 52 flowing around roll 308 contacts material 50 under pressure. Material 50 adheres to the flat or planar liner 52. The pressure may be applied via a pressure exerting device or roll 308 within the paperboard facing machine 300 to exert a pressure on the web of medium material flowing downstream F as the web 50 is adhered to the liner 52. The pressure exerted within facing machine 300 by pressure exerting device or roll 308 on the flowing web of medium material 50 and first liner 52 is from about 65 bar to about 85 bar. Preferably, the pressure is about 75 bar.

In operation and with primary reference to FIG. 7, corrugated medium 50 adhered to first liner 52 flows F from single facing machine 300 to double backer 500 along the sheet material pathway. When medium 50 is adhered to liner 52 it is known as a Single Face. Single Face flows around roller 404 towards roller 406 where adhesive 414 may be applied to create a bead 416 on the corrugated flute of medium 50. Adhesive roller 402 rotates in the direction flow stream F through an adhesive source 412. Adhesive source 412 includes starch and water, as well as other additives and modifiers as understood in the art.

In operation and with primary reference to FIG. 8, Single Face flows FROM 400 (adhesive applicator 400) having first liner adhered to corrugated medium 50 and having a bead of adhesive 416 deposited on the flutes opposing liner. Single Face flows towards toward the gap defined by first and second rollers 502, 504. Second liner 54 flows FROM 200 (heating apparatus 200) and also flows toward the gap defined by first and second rollers 502, 504. Single Face (medium 50 adhered to liner 52) meet and connect to second liner 54 in the gap defined by rollers 502, 504. Rollers 502, 504 apply pressure and effectively pinch together second liner 54 to the flutes of medium 50 at bead 416. Bead of adhesive 416 adheres second liner 54 to medium 50 creating a “double-backed” sheet of paperboard. The term double-backed refers to a sheet of manufactured paperboard 60 having two liners 52, 54 sandwiching a sinusoidally shaped medium material 50.

Formed paperboard 60 continues to flow F downstream. The upper portion of paperboard 60 (formerly first liner 52) contacts belt 518. Belt 518 is part of a drive system 510 configured to move paperboard 60 downstream. Drive system 510 may be powered via conventional manners as understood in the art of paperboard manufacturing. The lower portion of paperboard 60 (formerly second liner 54) flows downstream above hot plates 506.

Hot plates 506 are controlled by the steam pressure and temperature control system 508. Control system 508 controls the temperature of each plate 506a, 506b, 506c, 506d within the set of hot plates 506 through the use of pressurized steam from source 509, independent of the remaining hot plates within the set. The pressurized steam is contained within each plate to impart a temperature to the outer surface. The plates 506 may include at least four hot plates 506a, 506b, 506c, and 506d. The plates are arranged in a side-to-side manner from upstream to downstream. The plates vary in temperature from upstream to downstream. When viewed from the side (FIG. 8) the plate foremost upstream plate 506a is the coolest relative to the other plates. Looking at the downstream plates 506b, 506c, 506d, the temperature may stay equal to the prior plate, or the temperature may increase. The temperature of a plate is never less than the plate directly upstream from it. So by way of non-limiting example, for a Single Face sheet of material (medium 50 adhered to liner 52 without second liner 54) flowing F over plates 506 and if plate 506a is 320° F. (heated with 75 psi steam), then plate 506b (the plate directly downstream from plate 506a) must be at least the same temperature or hotter than 320° F. Stated otherwise, plate 506b cannot be cooler than 506a. If plate 506b is 328° F. (heated with 85 psi steam), then plate 506c (the plate directly downstream) cannot be cooler than 328° F. (it may be equal to 85 degrees). Thus, if plate 506c is also 328° F. (heated with 85 psi steam), then plate 506d (the plate directly downstream) cannot be cooler than 328° F. and is preferably about 330° F. Additionally, the set of hot plates 506 may be configured such that each hot plate 506a, 506b, 506c, 506d has a temperature not equal to any other plate in the set of hot plates 506.

Alternatively, by way of non-limiting example, for a double backed sheet of paperboard 60, the temperatures for the hot plates 506 may be slightly hotter than those described above for a Single Face. Thus, when a double backed sheet of paperboard 60 is formed by System 1000, when plate 506a is 330° F. (heated with 90 psi steam), then plate 506b (the plate directly downstream from plate 506a) must be at least the same temperature or hotter than 330° F. Stated otherwise, plate 506b cannot be cooler than 506a. If plate 506b is 338° F. (heated with 100 psi steam), then plate 506c (the plate directly downstream) cannot be cooler than 338° F. (it may be equal to 338 degrees). Thus, if plate 506c is also 344° F. (heated with 110 psi steam), then plate 506d (the plate directly downstream) cannot be cooler than 344° F. and could be about 355° F. (heated with 130 psi steam). The hot plates 506 for a double backed paperboard are all preferably less than or equal to 350° F. (heated with 120 psi steam)

Hot plates 506 cool paperboard 60 flowing atop to cure the adhesive applied in single facer 300, and applied in adhesive applicator 400. The configuration of hot plates 506 ensure paperboard 60 should not warp while uniformly drying (FIG. 9). Further, this configuration should produce even adhesive lines to prevent delamination (FIG. 10).

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the preferred embodiment of the invention are an example and the invention is not limited to the exact details shown or described.

1. A method comprising the steps of:
moving a sheet of material along a first sheet material pathway at a first linear velocity through a paperboard corrugating system, the first linear velocity in a first linear velocity range from 1 Feet Per Minute (FPM) to about 1500 FPM;
rotating a moisture applicator roll at a first tangential velocity in a direction opposite that of the moving sheet of material, wherein the first tangential velocity is a first percentage of the linear velocity;
wherein the first percentage is in a first tangential velocity percentage range from 20% to 90%; and
contacting the moving sheet of material with the moisture applicator roll to apply an aqueous solution at a contact location.

2. The method of claim 1, wherein the first tangential velocity range is from 20% to about 80%.

3. The method of claim 1, wherein the first tangential velocity range is from 20% to about 70%.

4. The method of claim 1, wherein the first tangential velocity range is from 20% to about 55%.

5. The method of claim 1, wherein the first tangential velocity range is from 20% to about 45%.

6. The method of claim 1, wherein the first tangential velocity range is from 20% to about 35%.

7. The method of claim 1, further comprising the step of:
moving the sheet of material within one of a first linear velocity sub-range from about 1 foot per minute (FPM) to about 100 FPM, a second linear velocity sub-range from about 100 FPM to about 300 FPM, a third linear velocity sub-range from about 300 FPM to about 500 FPM, a fourth threshold range from about 500 FPM to about 800 FPM, and a fifth linear velocity sub-range from 800 FPM and faster; and
wherein the tangential velocity is 100% when the first linear velocity is within the first sub-range;
wherein the tangential velocity is 80% when the first linear velocity is within the second sub-range;
wherein the tangential velocity is 70% when the first linear velocity is within the third sub-range;
wherein the tangential velocity is 55% when the first linear velocity is within the fourth sub-range;
wherein the tangential velocity is 45% when the first linear velocity is within the fifth sub-range.

8. The method of claim 1, further comprising the steps of:
moving a liner along a second pathway at a second linear velocity through the paperboard corrugating system, the second linear velocity of the liner in a second linear velocity range from 1 FPM to about 1500 FPM;
rotating a second moisture applicator roll at a second tangential velocity in a direction opposite that of the moving liner, wherein the second tangential velocity is a percentage of the second linear velocity;
wherein the second tangential velocity percentage value is in a second tangential velocity percentage range from 30% to 160%;
contacting the moving liner with the second moisture applicator roll to apply an aqueous solution at a contact location; and
attaching the liner to the sheet of material with an adhesive.

9. The method of claim 8, wherein the second tangential velocity percentage range is from 35% to about 55%.

10. The method of claim 8, wherein the second tangential velocity percentage range is from 55% to about 75%.

11. The method of claim 8, wherein the second tangential velocity percentage value range is from 75% to about 95%.

12. The method of claim 8, wherein the second tangential velocity percentage value range is from 95% to about 115%.

13. The method of claim 8, wherein the second tangential velocity percentage value range is from 115% to about 135%.

14. The method of claim 8, wherein the second tangential velocity percentage value range is from 135% to about 155%.

15. The method of claim 8, further comprising the steps of:
moving a second liner along a third pathway at a third linear velocity through the paperboard corrugating system, the third linear velocity in a third linear velocity range from 1 FPM to about 1500 FPM;
rotating a third moisture applicator roll at a third tangential velocity in a direction opposite that of the moving second liner, wherein the third tangential velocity is a percentage of the third linear velocity;
wherein the third tangential velocity percentage value is in a third tangential velocity percentage range from 30% to 160%;
contacting the moving second liner with the third moisture applicator roll to apply an aqueous solution at a contact location; and
attaching the second liner to the sheet of material via the adhesive spaced apart and opposite from the first liner.

16. The method of claim 15, wherein the third tangential velocity percentage value range is from 35% to about 55%.

17. The method of claim 15, wherein the third tangential velocity percentage value range is from 55% to about 75%.

18. The method of claim 15, wherein the third tangential velocity percentage value range is 75% to about 95%.

19. The method of claim 15, wherein the third tangential velocity percentage value range is from 95% to about 115%.

20. The method of claim 15, wherein the third tangential velocity percentage value range is from 115% to about 135%.

21. The method of claim 15, wherein the third tangential velocity percentage value range is from 135% to about 155%.
